(19) United States
(12) Patent Application Publication
(10) Pub. No.: US 2022/0309272 A1
(43) Pub. Date: Sep. 29, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventors: Tadao MICHIMURA, Kanagawa (JP); Shigeru OKADA, Kanagawa (JP); Fumi KOSAKA, Kanagawa (JP); Masanori YOSHIZUKA, Kanagawa (JP)

(73) Assignee: FUJIFILM Business Innovation Corp., Tokyo (JP)

(21) Appl. No.: 17/372,495

(22) Filed: Jul. 11, 2021

(30) Foreign Application Priority Data
Mar. 24, 2021 (JP) 2021-050793

(51) Int. Cl. G06K 9/00; G06T 11/20

(52) U.S. Cl. CPC G06K 9/00409; G06T 11/203; G06K 9/00463; G06K 9/00422; G06K 2209/01

(57) ABSTRACT

An information processing apparatus includes a processor configured to acquire each recognition result output by each of plural different recognition processes for the same image, and execute, in relation to the recognition result selected from among the recognition results output by each of the plural recognition processes, a postprocess corresponding to the recognition process from which the selected recognition result is output.

### CROSS-REFERENCE TO RELATED APPLICATIONS

This application is based on and claims priority under 35 USC 119 from Japanese Patent Application No. 2021-050793 filed Mar. 24, 2021.

### BACKGROUND

### (i) Technical Field

The present invention relates to an information processing apparatus and a non-transitory computer readable medium storing a program.

### (ii) Related Art

Along with advances in machine learning technologies such as deep learning, recognition engines or recognition dictionaries for various types of targets such as printed texts, handwritten texts, numbers, and musical scores are developed.

JP2006-092027A describes that a histogram is generated based on shading of pixels in image data, a text color, and the like, and the image data is separated into image data consisting of a print portion and image data consisting of a handwritten portion based on the histogram. Further, JP2006-092027A describes that the print portion is recognized by OCR for printing and the handwritten portion is recognized by OCR for handwriting.

Some OCR engines calculate and output a certainty degree of the recognition result.

### SUMMARY

Meanwhile, a method of calculating a feature of an image such as the shading histogram and selecting a recognition method to be applied to the image based on the feature requires a preprocess of calculating the feature. Therefore, a processing cost of the preprocess and a cost for developing the preprocess are incurred. For example, as the recognition method for recognizing a new kind of object is developed, it is a heavy burden to develop the preprocess for identifying an image representing the object.

Aspects of non-limiting embodiments of the present disclosure relate to an information processing apparatus and a non-transitory computer readable medium storing a program that execute a postprocess according to a type of an image on a recognition result of the image without calculating a feature of the image before a recognition process.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire each recognition result output by each of a plurality of different recognition processes for the same image, and execute, in relation to the recognition result selected from among the recognition results output by each of the plurality of recognition processes, a postprocess corresponding to the recognition process from which the selected recognition result is output.

### BRIEF DESCRIPTION OF THE DRAWINGS

Exemplary embodiment(s) of the present invention will be described in detail based on the following figures, wherein:

FIG. 1 is a block diagram illustrating a hardware configuration of an information processing apparatus according to the present exemplary embodiment;

FIG. 2 is a block diagram illustrating a configuration of a function of the information processing apparatus according to the present exemplary embodiment;

FIG. 3 is a flowchart illustrating a flow of a process according to Example 1;

FIG. 4 is a diagram illustrating an image which is a target of a recognition process;

FIG. 5 is a diagram illustrating a recognition result;

FIG. 6 is a diagram illustrating a specific example of a handling DB;

FIG. 7 is a diagram illustrating a result of a process by a processing unit;

FIG. 8 is a flowchart illustrating a flow of a process according to Example 2;

FIG. 9 is a diagram illustrating another recognition result;

FIG. 10 is a diagram illustrating still another recognition result; and

FIG. 11 is a diagram illustrating a text glyph.

### DETAILED DESCRIPTION

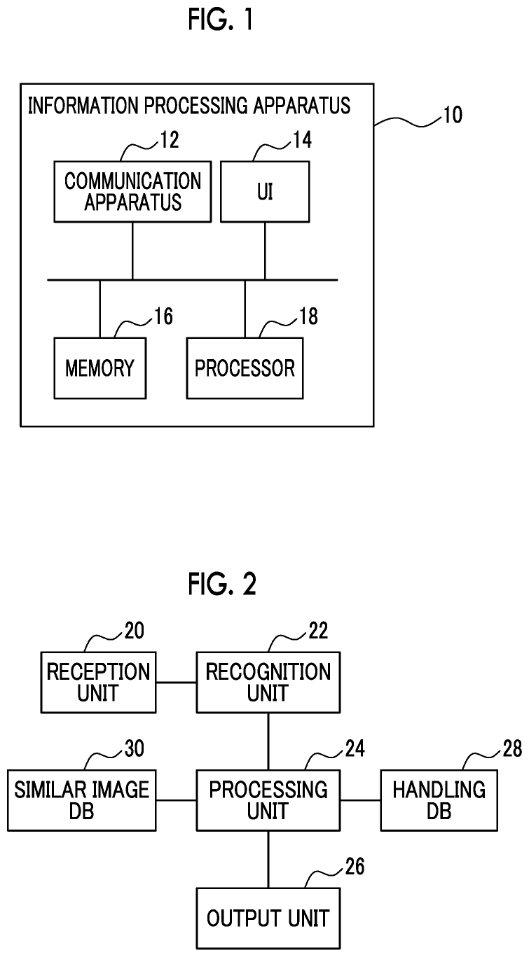

A hardware configuration of an information processing apparatus 10 according to the present exemplary embodiment will be described with reference to FIG. 1. FIG. 1 illustrates an example of a hardware configuration of the information processing apparatus 10. The information processing apparatus 10 includes, for example, a communication apparatus 12, a UI 14, a memory 16, and a processor 18.

The communication apparatus 12 is a communication interface having a communication chip, a communication circuit, and the like, and has a function of transmitting information to another apparatus and a function of receiving information from the other apparatus. The communication apparatus 12 may have a wireless communication function or a wired communication function.

The UI 14 is a user interface, and includes at least one of a display or an operation apparatus. The display is a display apparatus such as a liquid crystal display or an EL display. The operation apparatus is a keyboard, an input key, an operation panel, or the like. The UI 14 may be a UI such as a touch panel having both the display and the operation apparatus.

The memory 16 is an apparatus constituting one or a plurality of storage areas for storing various types of information. The memory 16 is, for example, a hard disk drive (HDD), a solid state drive (SSD), various types of memory (for example, RAM, DRAM, ROM, or the like), other storage apparatuses (for example, an optical disk and the like), or a combination the storage apparatuses. One or a plurality of memories 16 are included in the information processing apparatus 10.

The processor 18 is configured to control an operation of each unit of the information processing apparatus 10. The processor 18 may have a memory. For example, the processor 18 realizes each function described below.

The information processing apparatus 10 is, for example, a personal computer, a server, a scanner, a multifunction printer (for example, an apparatus including a scanner and a printer), a smartphone, or the like.

A functional configuration of the information processing apparatus 10 will be described with reference to FIG. 2. FIG. 2 illustrates an example of the functional configuration of the information processing apparatus 10.

The information processing apparatus 10 includes a reception unit 20, a recognition unit 22, a processing unit 24, an output unit 26, a handling DB (handling database) 28, and a similar image DB (similar image database) 30.

The reception unit 20 receives image data which is a target of a recognition process. Hereinafter, the “image data” will be abbreviated as an “image”. The image received by the reception unit 20 is output to the recognition unit 22. The reception unit 20 may receive an image generated by scanning a document by an imaging apparatus such as a scanner or a camera, or may receive an image transmitted via a communication path such as the Internet.

The recognition unit 22 executes the recognition process on the image, and outputs a result of the recognition process (hereinafter, referred to as a “recognition result”) to the processing unit 24. The recognition process is a process of recognizing texts (that is, symbols or codes that are associated with a language and express a meaning), or symbols or codes other than texts (that is, symbols or codes that are not associated with a language but have a meaning), from the image. Examples of the texts include hiragana, katakana, kanji, alphabets, Arabic texts, Latin texts, and the like. Examples of the symbols or the codes other than the text include ideographic texts such as numbers, pictograms, braille, punctuation marks, musical scores, mathematical formulas, phonetic symbols, and the like. Of course, the symbols or the codes other than the symbols or the codes may be recognized by the recognition unit 22. For example, optical character recognition (OCR) is an example of the recognition process. Specifically, OCR for handwriting, OCR for printing, OCR for numbers, OCR for musical scores, and the like are used.

The recognition unit 22 executes a plurality of different recognition processes on the same image. The recognition unit 22 may be configured with a plurality of different recognition engines, or may be configured with one recognition engine. Each of the plurality of different recognition engines performs different recognition processes. A plurality of different recognition processes may be realized by each of the plurality of different recognition engines executing the recognition process, or may be realized by one recognition engine executing the recognition process a plurality of times by changing parameters such as a recognition dictionary.

The processing unit 24 respectively acquires the recognition results output by the plurality of respective different recognition processes for the same image. For example, the processing unit 24 acquires recognition results output by the plurality of respective different recognition engines, or each recognition result output by one recognition engine executing the recognition process a plurality of times by changing parameters. In this manner, the processing unit 24 acquires the plurality of recognition results from the recognition unit 22.

Further, the processing unit 24 selects a recognition result from the acquired plurality of recognition results, and executes a postprocess corresponding to the recognition process by which the selected recognition result (for example, recognition engine or recognition dictionary) is output, in relation to the selected recognition result. The processing unit 24 may execute the postprocess on the recognition result, or may execute the postprocess on the image to be recognized, from which the recognition result is obtained.

The recognition unit 22 may calculate a certainty degree for each recognition result of the plurality of different recognition processes. The recognition unit 22 outputs each recognition result and the certainty degree in association with each other, to the processing unit 24. The certainty degree is information (for example, a numerical value) indicating reliability of the recognition result. A known technology can be used as a method for calculating the certainty degree. For example, the certainty degree may be calculated by using the technologies described in JP2006-244518A, JP2016-212812A, JP1993-040853A, JP1993-020500A, JP1993-290169A, and JP1996-101880A, or JP2011-113125A, JP2013-069132A, and the like.

In a case where the certainty degree of each recognition result is calculated and outputted to the processing unit 24 by the recognition unit 22, the processing unit 24 may acquire each recognition result and the certainty degree of each recognition result, select a recognition result based on the certainty degree among the plurality of recognition results, and execute the postprocess on the selected recognition result. For example, the processing unit 24 may select a recognition result having the highest certainty degree, or may select another recognition result having a certainty degree equal to or higher than a predetermined threshold value.

As another example, based on a variation in a height of each recognized text, the recognition unit 22 may recognize whether each of the texts is a handwritten text or a printed text. Further, in a case where an image on which musical scores are represented is a target of the recognition process, the recognition unit 22 may recognize that texts represented in an area in which the staff is drawn are printed texts.

The output unit 26 outputs the recognition result, the result obtained by the postprocess, and the like. The outputting the recognition result and the like includes, for example, displaying the recognition result and the like on a display, transmitting the recognition result and the like to an external apparatus by communication, storing the recognition result and the like in the memory, printing the recognition result and the like on a recording medium such as paper, generating a sound such as a voice expressing the recognition result and the like from a speaker, and the like.

The reception unit 20, the recognition unit 22, the processing unit 24, and the output unit 26 described above are realized by the processor 18. That is, the processor 18 acquires the recognition results output by each of the plurality of different recognition processes on the same image, and executes, in relation to a recognition result selected from the recognition results output by each of the plurality of recognition processes, a postprocess corresponding to the recognition process by which the selected recognition result is output. The memory 16 may be used for this realization.

The reception unit 20 and the recognition unit 22 are not included in the information processing apparatus 10, and the recognition process by the recognition unit 22 may be executed by an external apparatus other than the information processing apparatus 10. In this case, the processing unit 24 of the information processing apparatus 10 acquires the plurality of recognition results from the external apparatus, and executes a postprocess related to the recognition result selected from the plurality of recognition results.

The handling DB 28 is a database in which an example of the postprocess corresponding to the recognition result is registered.

The similar image DB 30 is a database in which an image which is a target for the recognition process and a recognition result are registered. For example, the image which is a target for the recognition process and the recognition result obtained by the recognition process for the image are associated with each other, and registered in the similar image DB 30. The similar image DB 30 may not be included in the information processing apparatus 10.

Hereinafter, each example of the present exemplary embodiment will be described.

### Example 1

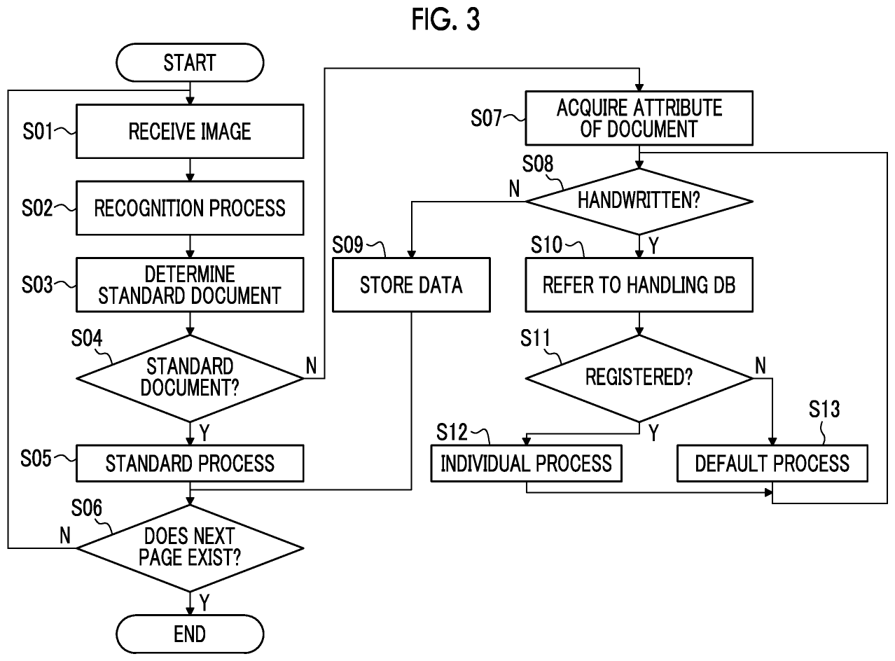

Hereinafter, a process according to Example 1 will be described with reference to FIG. 3. FIG. 3 is a flowchart illustrating a flow of the process according to Example 1.

In Example 1, recognition processes executed by the recognition unit 22 are a printed text recognition process and a handwritten text recognition process.

The printed text recognition process is, for example, a process of comparing a text pattern of a print with a printed text pattern registered in a print dictionary by a pattern matching method, and outputting a printed text pattern having a high degree of similarity (for example, a printed text pattern having the highest degree of similarity or a printed text pattern having the degree of similarity equal to or higher than a threshold value) as a recognition result.

The handwritten text recognition process is, for example, a process of executing a process of clipping an area including texts from the image one text at a time or a preprocess such as a tilt correction process, comparing features extracted from the handwritten text and features of each text registered in the handwritten text dictionary, and outputting a text having a high degree of similarity (for example, a text having the highest degree of similarity or a text having the degree of similarity equal to or higher than a threshold value) as the recognition result.

In a case where an image is input to the information processing apparatus 10, the reception unit 20 receives the image (step S01). The reception unit 20 outputs the received image to the recognition unit 22. This image is an image which is a target of a recognition process. As an example in Example 1, the image which is a target of the recognition process is an image representing a document.

The recognition unit 22 executes a plurality of different recognition processes on the same image received by the reception unit 20 (step S02). In Example 1, the recognition unit 22 executes the printed text recognition process and the handwritten text recognition process on the same image, and outputs a printed text recognition result which is a result of the printed text recognition process and the handwritten text recognition result which is a result of the handwritten text recognition process to the processing unit 24.

Further, the recognition unit 22 determines whether or not the document represented by the image which is a target of the recognition process is a standard document (step S03). A known technology can be used for this determination. For example, various types of standard document formats are registered in advance in a DB or the like, and the recognition unit 22 compares a document format represented by the image which is a target of the recognition process with various types of standard document formats registered in the DB or the like in advance to determine whether or not the document represented by the image which is a target of the recognition process is a standard document. In a case where a format that coincides with or is similar to the format of the document represented by the image which is a target of the recognition process is registered in the DB or the like, the recognition unit 22 determines that the document represented by the image which is a target of the recognition process is a standard document. In a case where the format that coincides with or is similar to the format of the document represented by the image which is a target of the recognition process is not registered in the DB or the like, the recognition unit 22 determines that the document represented by the image which is a target of the recognition process is not the standard document (that is, a “non-standard document”). As another method, a two-dimensional code or the like for identifying a type of the document is formed in the document represented by the image which is a target of the recognition process, and the recognition unit 22 may determine the type of the document, and determine whether or not the document is a standard document, based on the two-dimensional code or the like.

In a case where the document represented by the image which is a target of the recognition process is the standard document (Yes in step S04), the processing unit 24 executes a standard process corresponding to the standard document on the image (step S05). For example, the standard process is predetermined for each type of standard document, and the processing unit 24 executes the standard process according to the type of standard document represented in the document which is a target of the recognition process, on the image. The standard process is, for example, a process of distinguishing and recognizing handwritten texts and printed texts from the image which is a target of the recognition process, and converting the handwritten texts and the printed texts into data.

The recognition unit 22 executes a process of step S01 to step S05 for each page of the document. In a case where the document does not have the next page (Yes in step S06), the process is ended. In a case where the document has the next page (No in step S06), the process returns to step S01.

In a case where the document represented by the image which is a target of the recognition process is not the standard document (No in step S04), that is, in a case where the document is a non-standard document, the processing unit 24 acquires an attribute of the document (step S07). The attribute of the document here is a text type or a text code described in the document. The type of text is that the text is a handwritten text or a printed text.

For example, the recognition unit 22 executes the printed text recognition process and the handwritten text recognition process to obtain respective recognition results (that is, the printed text recognition result and the handwritten text recognition result). The processing unit 24 selects a result having high recognition accuracy from the printed text recognition result and the handwritten text recognition result for an image representing a certain text as the recognition result for the image. For example, in a case where accuracy of the handwritten text recognition result for the image representing the certain text is higher than accuracy of the printed text recognition result, the processing unit 24 recognizes the text as a handwritten text, and selects the handwritten text recognition result as a recognition result of the text. On the other hand, in a case where the accuracy of the printed text recognition result for the image representing the certain text is higher than the accuracy of the handwritten text recognition result, the processing unit 24 recognizes the text as a printed text, and selects the printed text recognition result as the recognition result of the text. The same applies to other texts. The recognition unit 22 may calculate a certainty degree of each recognition result, and the processing unit 24 may select a recognition result having a higher certainty degree from the printed text recognition result and the handwritten text recognition result.

In a case where a handwritten text is not represented in the image which is a target of the recognition process (No in step S08), the processing unit 24 associates information indicating that the handwritten text is not represented in the image with the image, and stores the information and the image in the memory 16 as a recognition result (step S09). That is, the information indicating that the handwritten text is not represented in the image and the image are associated with each other and converted into data, and the data is saved.

In a case where the handwritten text is represented in the image which is a target of the recognition process (Yes in step S08), the processing unit 24 refers to the handling DB 28 to check whether or not a postprocess corresponding to the handwritten text is registered in the handling DB 28 (step S10).

In a case where the postprocess corresponding to the recognized handwritten text is registered in the handling DB 28 (Yes in step S11), the processing unit 24 executes the postprocess, which is an example of an individual process, on the image which is a target of the recognition process or the recognition result (for example, the handwritten text recognition result) (step S12). A result of the postprocess is stored in, for example, the memory 16.

In a case where the postprocess corresponding to the recognized handwritten text is not registered in the handling DB 28 (No in step S11), the processing unit 24 executes a default process on the image which is a target of the recognition process or the recognition result (for example, the handwritten text recognition result) (step S13). A result of the default process is stored in, for example, the memory 16.

The processing unit 24 executes the process along the flow of step S10 to step S13, on all the handwritten texts.

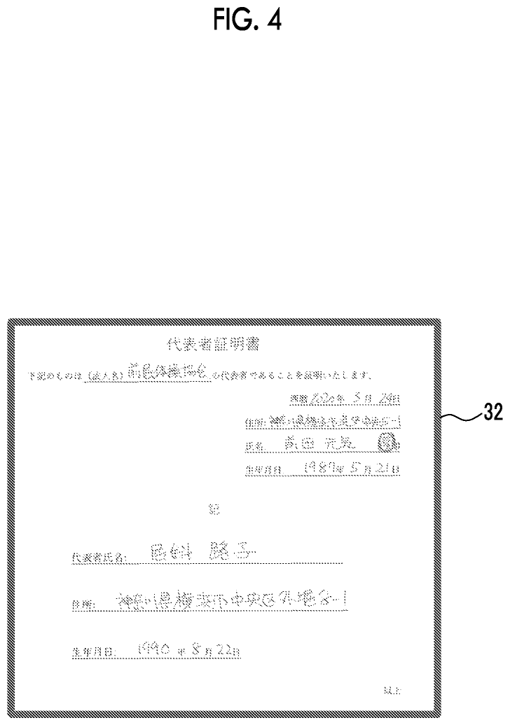

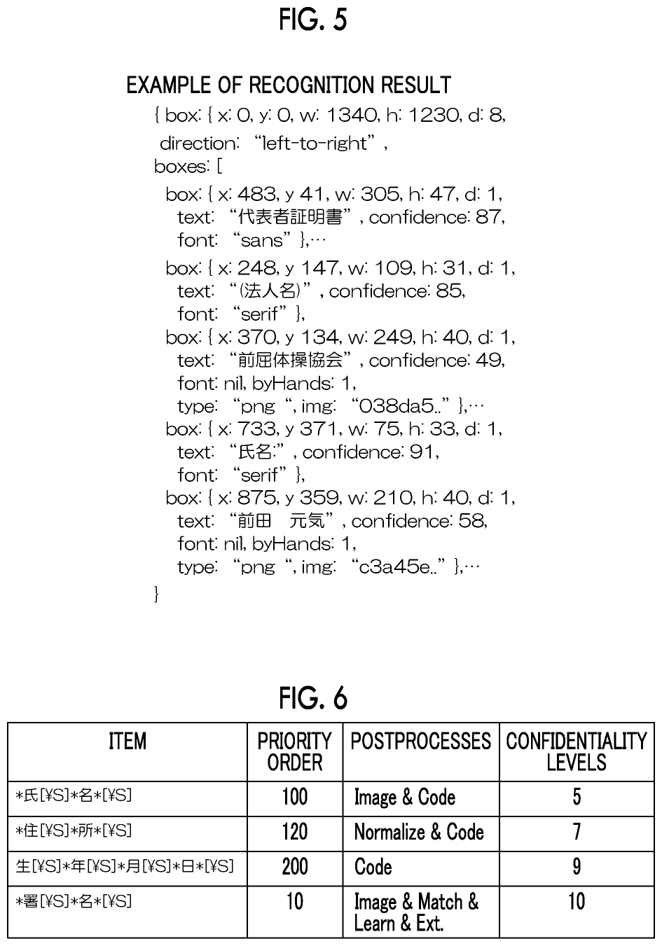

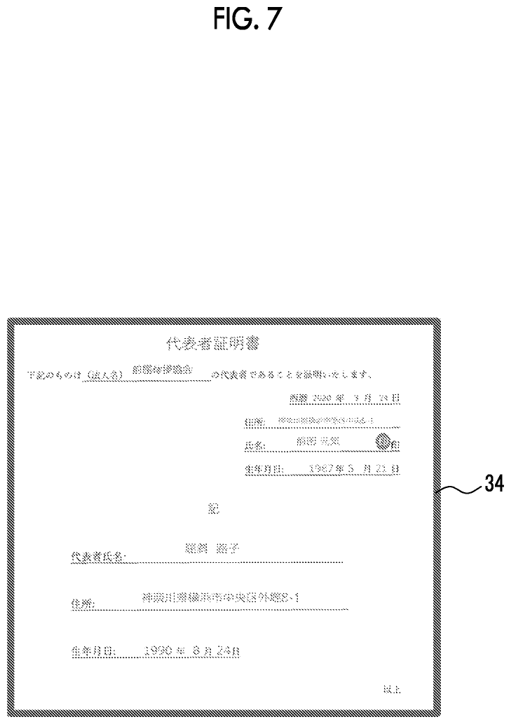

Hereinafter, a specific example of Example 1 will be described with reference to FIGS. 4 to 7. FIG. 4 illustrates an image 32 which is a target of a recognition process. FIG. 5 illustrates an example of a recognition result. FIG. 6 illustrates a specific example of the handling DB 28. FIG. 7 illustrates a result obtained by a process by the processing unit 24.

The image 32 is an example of an entire image, and a process by the information processing apparatus 10 is executed for each area in the image 32 which is the entire image. That is, the recognition process, acquisition of the recognition result, and a postprocess are executed on an image of each area.

Here, as an example, Example 1 will be described by using a procedure and a process when opening a corporate account at a financial institution such as a bank, as an example.

For example, in a case of opening the corporate account at the financial institution, an application for opening the account and a document called a “ [symbol] (representative certificate)” for certifying a representative of a corporation are submitted to the financial institution. For example, the account opening application and the representative certificate are scanned by a scanner, so that an image representing the account opening application and an image representing the representative certificate are generated. These images are targets of the recognition process, and the reception unit 20 receives these images.

The recognition unit 22 recognizes each image received by the reception unit 20 one by one. For example, the account opening application is a first sheet of document, and is a standard document. The representative certificate is a second sheet of document, and is a non-standard document. The image 32 illustrated in FIG. 4 is an image representing the representative certificate. The image representing the account opening application is not illustrated in FIG. 4.

The recognition unit 22 recognizes a document represented by the image of the first sheet as a standard document called an account opening application, and executes a standard process corresponding to the account opening application on the image of the first sheet. The standard process includes a printed text recognition process and a handwritten text recognition process corresponding to the account opening application. For example, from the image representing the account opening application, the recognition unit 22 recognizes each item such as an account type, an account name, and a deposit amount, extracts a printed text or a handwritten text described in each item as a text corresponding to each item, and converts the extracted text into data.

The recognition unit 22 recognizes a document represented by the image 32 of the second sheet (that is, the representative certificate) as a non-standard document attached to the account opening application, and outputs a recognition result (that is, a printed text recognition result which is a result of the printed text recognition process and a handwritten text recognition result which is a result of the handwritten text recognition process) to the processing unit 24.

FIG. 5 illustrates an example of the recognition result. In FIG. 5, “box” is an area in the image 32 which is an entire image. The “box” includes pieces of information indicating coordinates of the “box” in the image 32, a text string recognized by the recognition process (that is, the printed text recognition process or the handwritten text recognition process) on the text string described in the “box”, and a certainty degree of the recognition process, a font type of the recognized text, and whether the recognized text is a printed text or a handwritten text associated with each other as the recognition result. In this manner, the recognition unit 22 outputs the recognition result for each area by executing the recognition process for each area. As will be described below, the processing unit 24 executes a postprocess for each area.

The processing unit 24 determines that the handwritten text is a text written by a user. In a case where the recognition process is the handwritten text recognition process, the processing unit 24 executes a process corresponding to an item indicated by a recognition result for a partial image, which is a partial image in the vicinity of the area (that is, “box”) in the image 32 which is the entire image, in which the recognition result of the printed text recognition process is selected, as the postprocess. The partial image is an example of a second image. Hereinafter, this process will be described in detail.

In order to estimate a meaning of the handwritten text, the processing unit 24 estimates a direction in which the text is described in the representative certificate. For example, the processing unit 24 estimates the direction in which the text is described, based on an array of the texts. In the example illustrated in FIG. 5, the direction in which the texts are written is a horizontal writing direction, and the processing unit 24 estimates that the direction in which the texts are written in the document represented by the image 32 is the horizontal writing direction. More specifically, the processing unit 24 recognizes that the texts are written from the left side to the right side.

The processing unit 24 searches for a recognition result for a partial image, which is a partial image on the left side of an area (that is, “box”) in which a handwritten text string of “ [symbol] (forward bending gymnastics association)” which is a recognition result of the handwritten text recognition process is recognized, for which a recognition result of the printed text recognition process is selected, in the image 32. In the example illustrated in FIG. 4, since the texts are estimated to be written from the left side to the right side, the partial image of the area on the left side of the area, in which the handwritten text string of “ [symbol] [symbol] (forward bending gymnastics association)” is recognized, corresponds to the second image in the vicinity. The recognition result of the printed text recognition process for the partial image is a printed text string of “( [symbol] ) (corporate name)”. The processing unit 24 recognizes the printed text string of “( [symbol] )(corporate name)” as an item corresponding to the handwritten text string of “ [symbol] (forward bending gymnastics association)”, and searches the handling DB 28 for a postprocess corresponding to the item.

Here, a specific example of the handling DB 28 will be described with reference to FIG. 6. As illustrated in FIG. 6, in the handling DB 28, for example, items, priority orders, postprocesses, and confidentiality levels are associated with each other. The item is defined according to, for example, a regular expression. For example, an item of “ [symbol] (name)” is defined according to a regular expression of [ [symbol] (last name) [$S]* [symbol] (first name)*[$S]]. The priority order is a priority order of executing the postprocess.

As the postprocesses, for example, “Image”, “Code”, “Normalize”, “Match”, “Learn”, and “Ext” are registered.

The “Image” is a process of storing an image which is a target of a recognition process in a memory. The “Code” is a process of storing a text code of a recognition result in the memory. The “Normalize” is a process of normalizing the recognition result (for example, unifying or simplifying an address representation). The “Match” is a process of calculating the degree of coincidence between an image stored in the memory and an image which is a target of the recognition process, and extracting attributes of the image having a high degree of coincidence (for example, an image having the highest degree of coincidence or an image having the degree of coincidence equal to or higher than a threshold value). The “Ext” is a process of extending a storage expiration date of contents related to the image to be recognized.

The confidentiality level is a level indicating the degree of confidentiality of the recognized text. A process which makes visibility more difficult is executed on the text having a higher confidentiality level. For example, a text string corresponding to a confidentiality level of “5” is general privacy information, and is a text string which is permitted to be viewed by a general employee of a financial institution, for example. A text string corresponding to a confidentiality level of “10” is a text string which is not permitted to be viewed by anyone other than the person himself or herself, and is a text string on which a confidentiality process such as blackening at a time of rendering is executed, for example.

Since the item called the printed text string of “( [symbol] [symbol] ) (corporate name)” described above is not registered in the handling DB 28, the processing unit 24 executes a default process on the handwritten text string of “ [symbol] (forward bending gymnastics association)”.

In addition, the processing unit 24 searches for a recognition result for a partial image, which is a partial image on the left side of an area (that is, “box”) in which a handwritten text string of “ [symbol] (Maeda Genki)” which is a recognition result of the handwritten text recognition process is recognized, for which a recognition result of the printed text recognition process is selected, in the image 32. In the example illustrated in FIG. 4, the partial image of the area on the left side of the area, in which the handwritten text string of “ [symbol] (Maeda Genki)” is recognized, corresponds to the second image in the vicinity. The recognition result of the printed text recognition process for the partial image is a printed text string of “ [symbol] : (name:)”. The processing unit 24 recognizes the printed text string of “ [symbol] : (name:)” as an item corresponding to the handwritten text string of “ [symbol] (Maeda Genki)”, and searches the handling DB 28 for a postprocess corresponding to the item. As illustrated in FIG. 6, in the handling DB 28, the item of “ [symbol] (name)” is defined according to the regular expression of [ [symbol] (last name) [$S]* [symbol] (first name)*[$S]]. The processing unit 24 refers to the handling DB 28, specifies a postprocess and a confidentiality level corresponding to the item of “ [symbol] [symbol] (name)”, and associates the confidentiality level with the handwritten text string of “ [symbol] (Maeda Genki)” which is a recognition result of the handwriting recognition process. Further, the processing unit 24 executes the “Image” and the “Code” which are postprocesses corresponding to the item of “ [symbol] (name)” on the handwritten text string of “ [symbol] (Maeda Genki)” which is the recognition result or a part representing the handwritten text string of “ [symbol] (Maeda Genki)” in the image 32.

As described above, even in a case where the document represented by the image 32, which is a target of the recognition process, is not a standard document registered in advance, and is a non-standard document, it is possible to specify an item corresponding to the handwritten text from the document, and to execute a postprocess corresponding to the specified item on the handwritten text.

In the same manner, the processing unit 24 executes the process described above on other handwritten text strings. For example, each recognition result is stored in the memory 16.

The processing unit 24 may superimpose the recognition result on the image 32. For example, the image 32 on which the recognition result is superimposed is displayed on the display. FIG. 7 illustrates an image 34 generated by superimposing the recognition result on the image 32. The image 34 does not represent the handwritten text string represented by the image 32, which is a target of the recognition process. The processing unit 24 converts the handwritten text string into a printed text, and superimposes the converted text string on the image 32. For example, the handwritten text string of “ [symbol] (Maeda Genki)” is converted into a printed text, and illustrated in the image 34. The same applies to other handwritten text strings.

Further, the processing unit 24 executes the confidentiality process according to a confidentiality level associated with each handwritten text string. The confidentiality process is also an example of the postprocess. For example, since the confidentiality level is not associated with the handwritten text string of “ [symbol] (forward bending gymnastics association)”, the processing unit 24 renders the text string of “ [symbol] (forward bending gymnastics association)” in a default red color. Since the confidentiality level of the handwritten text string of “ [symbol] [symbol] (Maeda Genki)” is “5”, the processing unit 24 renders the text string of “ [symbol] (Maeda Genki)” in a green color corresponding to the confidentiality level. The green color is a color which reflects privacy information for an account opening staff. For example, the account opening staff confirms the information on opening the account displayed on the display and the image 34, and performs a procedure for opening the account.

The confidentiality process described above is only an example. The confidentiality process may be a blackening process, an encryption process, or another invisibleness process on a part in which a handwritten text is represented in the image 32 which is a target of the recognition process or the handwritten text which is a recognition result.

The processing unit 24 may execute the confidentiality process on the handwritten text, without specifying the second image and the item described above.

The processing unit 24 may discard the recognition result of the handwritten text and store the image 32 which is a target of the recognition process in the memory, or extract a partial image in which the recognition result of the handwritten text is represented in the image 32, from the image 32 and store the partial image in the memory. For example, for a text which has a meaning in a glyph such as a signature, the processing unit 24 stores not a text code but the image representing the text in the memory.

The recognition result of the handwritten text, the image which is a target of the recognition process, and writer information for identifying a writer of the text of the recognition result may be associated with each other, and registered in the similar image DB 30. In this case, the processing unit 24 may learn a feature amount for each writer and improve accuracy of recognition by comparing a combination of the image which is a target of the recognition process, the recognition result, and the writer with the information registered in the similar image DB 30.

The processing unit 24 may store a recognition result of a certain text and recognition process information (for example, information indicating a recognition engine or a recognition dictionary) which is information indicating a recognition process from which the recognition result is obtained in association with each other, in the memory. For example, in a case of selecting a handwritten text recognition result from a printed text recognition result and a handwritten text recognition result for a certain text, based on a certainty degree, accuracy, or the like, for this text, the processing unit 24 stores the handwritten text recognition result and the recognition process information indicating the handwritten text recognition process of the text in association with each other, in the memory. In a case of selecting a printed text recognition result from the printed text recognition result and the handwritten text recognition result for a certain text, for this text, the processing unit 24 stores the printed text recognition result and the recognition process information indicating the printed text recognition process of the text in association with each other, in the memory. In description by using a specific example, the processing unit 24 selects the handwritten text recognition result which is a result of the handwritten text recognition process for the text string of “ [symbol] (Maeda Genki)”, so that the handwritten text recognition result (that is, the handwritten text string of “ [symbol] (Maeda Genki)”) and the recognition process information indicating the handwritten text recognition process are associated with each other, and stored in the memory. Further, for the text string of “ [symbol] (forward bending gymnastics association)”, the processing unit 24 selects the printed text recognition result which is a result of the printed text recognition process, so that the printed text recognition result (that is, the printed text string of “ [symbol] (forward bending gymnastics association)”) and the recognition process information indicating the printed text recognition process are associated with each other, and stored in the memory.

The processing unit 24 may execute a postprocess corresponding to the recognition process indicated by the recognition process information associated with the recognition result, on the image which is a target of the recognition process or the recognition result. For example, in a case where the recognition process information indicating the handwritten text recognition process is associated with the recognition result, the processing unit 24 executes the postprocess (for example, the confidentiality process) corresponding to the handwritten text recognition process on the recognition result. In this manner, the processing unit 24 may execute the postprocess corresponding to the recognition process associated with the recognition result on the recognition result, without analyzing the recognition result.

### Example 2

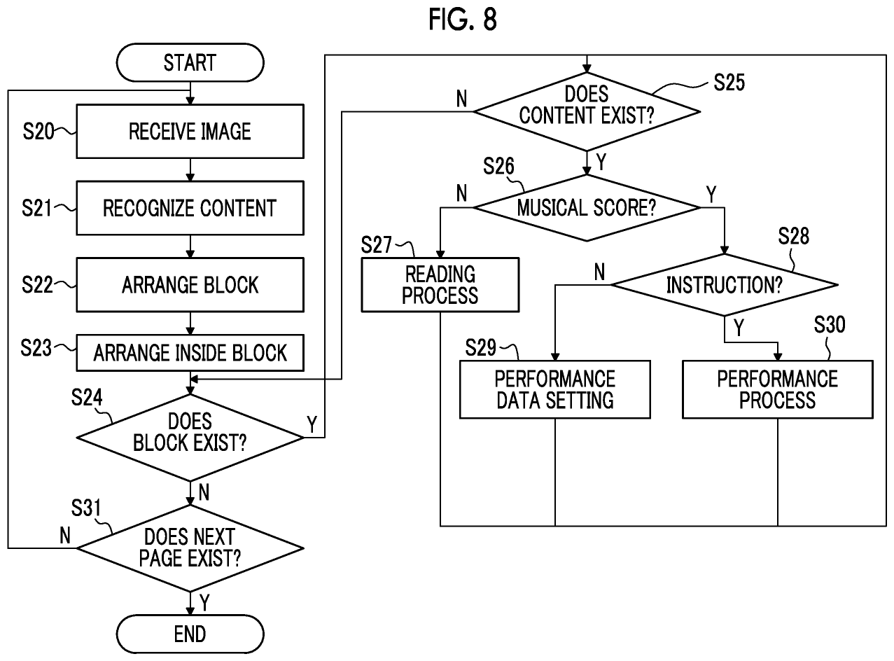

Hereinafter, a process according to Example 2 will be described with reference to FIG. 8. FIG. 8 is a flowchart illustrating a flow of the process according to Example 2. In Example 2, an image which is a target of a recognition process is an image representing a musical score. The recognition process is executed on the image representing the musical score, and a postprocess according to the recognition result is executed.

In a case where an image is input to the information processing apparatus 10, the reception unit 20 receives the image (step S20). The reception unit 20 outputs the received image to the recognition unit 22.

The recognition unit 22 executes the recognition process on the image received by the reception unit 20 to recognize contents represented by the image (step S21). In Example 2, the recognition unit 22 executes a process of recognizing texts from the musical score and a process of recognizing symbols such as musical notes (that is, symbols other than the texts) from the musical score on the image, and outputs a recognition result of each process to the processing unit 24.

The recognition unit 22 divides the image received by the reception unit 20 into a plurality of blocks (step S22), and arranges each block based on a drawing direction of the text or the symbol represented in each block and a size of the text or the symbol (step S23). For example, in a case where the drawing direction of the text or the symbol is from left to right, the recognition unit 22 recognizes that the text or the symbol is described from the upper left to the lower right. That is, the recognition unit 22 recognizes horizontal writing. In a case where the drawing direction of the text or the symbol is from right to left, the recognition unit 22 recognizes that the text or the symbol is described from the upper right to the lower left. That is, the recognition unit 22 recognizes horizontal writing. In a case where the drawing direction of the text or the symbol is from top to bottom, the recognition unit 22 recognizes that the text or the symbol is described from the upper right to the lower left. That is, the recognition unit 22 recognizes vertical writing.

In a case where there is an unprocessed block (Yes in step S24), the recognition unit 22 recognizes a head content in an arranged head block.

In a case where the content is recognized (Yes in step S25) and the content does not constitute the musical score (No in step S26), the processing unit 24 executes a process of reading the content as a postprocess (step S27). For example, in a case where the content is a text string, the processing unit 24 executes a process of reading the text string as the postprocess.

Ina case where the content constitutes the musical score (Yes in step S26) and the content indicates an instruction (for example, an instruction such as tempo) (Yes in step S28), the processing unit 24 sets performance data of the musical score, as the postprocess (step S29).

In a case where the content does not indicate an instruction (No in step S28), the processing unit 24 plays the musical score, as the postprocess (step S30). For example, in a case where the musical score indicates a musical note, the processing unit 24 plays the musical note.

The information processing apparatus 10 executes the process according to a flow from step S26 to step S30 until the content in the block does not exist (see step S25). Further, the information processing apparatus 10 executes the processing according to a flow from step S26 to step S30 until there are no unprocessed blocks (see step S24). Further, the information processing apparatus 10 performs the process for each page, and performs the process until there are no unprocessed pages (see step S31).

As described above, the processing unit 24 executes different postprocesses, depending on whether the content recognized from the musical score is a text or the recognized content constitutes the musical score. Further, in a case where the recognized content constitutes the musical score, the processing unit 24 executes the different postprocesses depending on whether or not the content is a musical note.

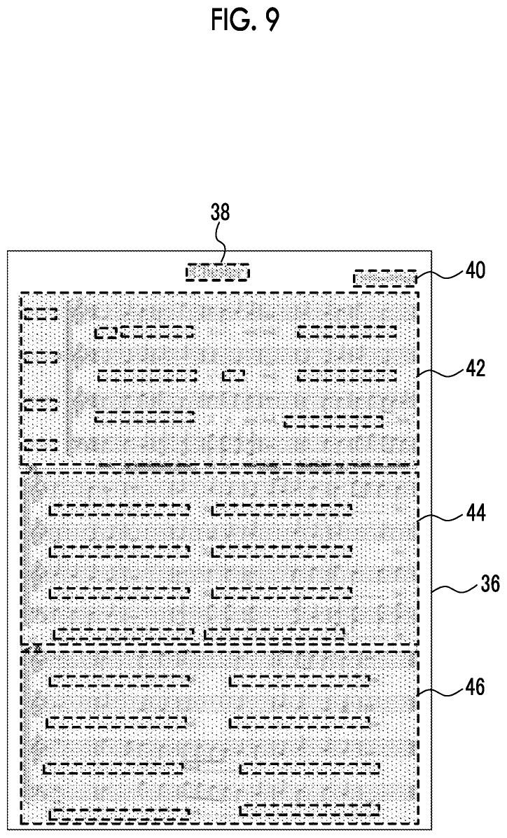

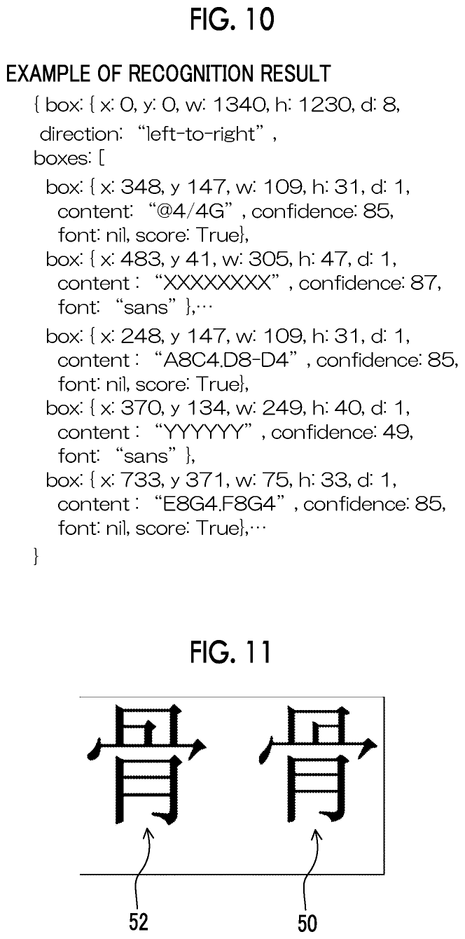

Hereinafter, a specific example of Example 2 will be described with reference to FIG. 9 and FIG. 10. FIG. 9 and FIG. 10 illustrate an example of a recognition result. In FIG. 9, a recognition result 36 of a musical score is illustrated as an image. FIG. 10 illustrates a part of the recognition result of the musical score.

As illustrated in FIG. 9, the recognition unit 22 sets blocks 38, 40, 42, 44, and 46 in the recognition result 36. Further, a plurality of blocks are also set in the blocks 42, 44, and 46. For example, the recognition unit 22 extracts a chunk of contents as one block by enlarging each part in the image and superimposing the part on another part.

For example, the recognition unit 22 estimates a structure from an inclusion relationship of the contents of each block. In the example illustrated in FIG. 9, the blocks 38, 40, 42, 44, and 46 are estimated, and the plurality of blocks are estimated within these blocks.

The block 38 is a block including a text string indicating a title of the musical score.

The block 40 is a text string indicating an author.

The block 42 is an area representing a staff notation consisting of four parts. Specifically, the block 42 includes a block of the musical score drawn on the staff notation, a block of part names, and a block of lyrics of each part.

The block 44 is an area representing a staff notation consisting of four parts. Specifically, the block 44 includes a block of numbers, a block of the musical score drawn on the staff notation, and a block of lyrics of each part.

The block 46 is an area representing a staff notation consisting of four parts. Specifically, the block 46 includes a block of numbers, a block of the musical score drawn on the staff notation, and a block of lyrics of each part.

In the example illustrated in FIG. 9, the recognition unit 22 recognizes that an arrangement direction of the parts constituting the musical score and the text string is from left to right, and an appearance order of the texts and the symbols is from top to bottom and from left to right.

The processing unit 24 executes a postprocess according to the contents of the block for each block. For example, since the text string indicating the title of the musical score is represented in the block 38 and the text string indicating the author is represented in the block 40, the processing unit 24 executes a process of reading the text strings represented in each of the blocks 38 and 40. Further, since the symbol such as a musical note is represented in the blocks 42, 44, and 46, the processing unit 24 executes a performance process according to the symbol represented in each of the blocks 42, 44, and 46.

### Example 3

Hereinafter, Example 3 will be described. In Example 3, the recognition unit 22 executes a first text recognition process and a second text recognition process on an image which is a target of a recognition process, and outputs a first recognition result which is a result of the first text recognition process and a second text recognition result which is a result of the second text recognition process. The first recognition result and the second recognition result are output to the processing unit 24.

The first text recognition process is a process of recognizing an image which is a target of the recognition process as an image representing texts in a first language, and outputting a text code as a recognition result, as the first recognition result.

The second text recognition process is a process of recognizing an image which is a target of the recognition process as an image representing texts in a second language, and outputting a text code as a recognition result, as the second recognition result. The second language is a language different from the first language.

Although Example 3 will be described here by taking two languages (that is, the first language and the second language) as an example, a process according to Example 3 by using as three or more languages as targets may be executed. In this case, a third text recognition process corresponding to a third language or a fourth text recognition process corresponding to a fourth language is executed.

The processing unit 24 executes a postprocess corresponding to the first text recognition process on the first recognition result, and executes a postprocess corresponding to the second text recognition process on the second recognition result.

For example, the recognition unit 22 executes the first text recognition process and the second text recognition process on the same image to obtain the respective recognition results (that is, the first recognition result and the second recognition result). The processing unit 24 selects a result having high recognition accuracy from the first recognition result and the second recognition result for the image representing a certain text, as the recognition result for the image. For example, in a case where accuracy of the first recognition result for the image representing the certain text is higher than accuracy of the second recognition result, the processing unit 24 recognizes the text as a text of the first language, and selects the first recognition result. The same applies to other texts. The recognition unit 22 may calculate a certainty degree of each recognition result, and the processing unit 24 may select a recognition result having a higher certainty degree from the first recognition result and the second recognition result.

In a case where the recognition process from which the selected recognition result is output is the first text recognition process, the processing unit 24 uses a text glyph indicated by the text code as the postprocess to execute a process of drawing the text glyph indicated by the text code in a glyph set of the first language.

In a case where the recognition process from which the selected recognition result is output is the second text recognition process, the processing unit 24 uses a text glyph indicated by the text code as the postprocess to execute a process of drawing the text glyph indicated by the text code in a glyph set of the second language.

For example, the first language is Japanese. The first text recognition process is a process of recognizing an image which is a target of the recognition process as an image representing Japanese texts, and outputting a Japanese text code as the recognition result. As a postprocess, the processing unit 24 describes a text glyph indicating the text code in a Japanese glyph set, as a text glyph indicated by the text code. That is, the processing unit 24 renders the text code with the Japanese glyph.

For example, the second language is Korean. The second text recognition process is a process of recognizing an image which is a target of the recognition process as an image representing a Korean text, and outputting a Korean text code as the recognition result. As a postprocess, the processing unit 24 describes a text glyph indicating the text code in a Korean glyph set, as a text glyph indicated by the text code. That is, the processing unit 24 renders the text code with the Korean glyph.

In addition, the processing unit 24 may store a recognition result and recognition process information which is information indicating a recognition process from which the recognition result is obtained in association with each other, in the memory. For example, in a case of selecting a first recognition result (that is, a recognition result in Japanese) as a recognition result for a certain text, the processing unit 24 stores the first recognition result and recognition process information indicating a first text recognition process in association with each other, in the memory. In the same manner, in a case of selecting a second recognition result (that is, a recognition result in Korean) as a recognition result for a certain text, the processing unit 24 stores the second recognition result and recognition process information indicating a second text recognition process in association with each other, in the memory. In this case, the processing unit 24 may execute a postprocess corresponding to the recognition process indicated by the recognition process information associated with the recognition result, on the image which is a target of the recognition process or the recognition result. For example, in a case where the recognition process information indicating the first text recognition process is associated with the recognition result, the processing unit 24 executes a postprocess (for example, rendering by using a Japanese glyph) corresponding to the first text recognition process for the recognition result.

FIG. 11 illustrates an example of a text glyph. Text glyphs 50 and 52 are text glyphs expressing “ [symbol] (bone)”. The text glyph 50 is a text glyph that expresses a Japanese text, and the text glyph 52 is a text glyph that expresses a Korean text. In this manner, even in a case where the texts have the same meaning, the text glyphs differ depending on the language. Such variant texts exist. In Unicode and ISO/IEC 10646 (USC), it may be possible to distinguish the variant texts by a variant text selector, and it is not possible to distinguish the variant text, in some cases.

In Example 3, recognition process information is associated with a recognition result and output. Therefore, by referring to the recognition process information, it is possible to discriminate which recognition process the recognition result, with which the recognition process information is associated, is the result obtained. For example, the recognition process information indicating a first text recognition process is associated with a recognition result of a text represented by the text glyph 50, and the text is discriminated to be a text recognized by the first text recognition process for Japanese. In the same manner, the recognition process information indicating a second text recognition process is associated with a recognition result of a text represented by the text glyph 52, and the text is discriminated to be a text recognized by the second text recognition process for Korean. By associating the recognition process information with the recognition result in this manner, it is possible to distinguish the variant texts.

### Example 4

Hereinafter, Example 4 will be described. In Example 4, an image which is a target of a recognition process is an image representing an ancient document. In the ancient document, text glyphs may differ depending on an era of creating the ancient document and a creator of the ancient document. That is, even texts having the same meaning may be represented by different text glyphs depending on the era of creating the ancient document and the creator of the ancient document.

In Example 4, the recognition unit 22 executes a first text recognition process corresponding to a first era and a first creator and a second text recognition process corresponding to a second era and a second creator on the same image which is a target of a recognition process (that is, an image which represents the ancient document). The second era is different from the first era. The second creator is a creator different from the first creator.

The first text recognition process is a process of recognizing the image which is a target of the recognition process as the image representing the text created by the first creator in the first era, and outputting a text code as the recognition result, as a first recognition result.

The second text recognition process is a process of recognizing the image which is a target of the recognition process as the image representing the text created by the second creator in the second era, and outputting a text code as the recognition result, as a second recognition result.

In the same manner as Example 3, a third text recognition process corresponding to a third era and a third creator and a fourth text recognition process corresponding to a fourth era and a fourth creator may be executed on the same image.

The processing unit 24 selects a recognition result having high accuracy and a recognition result having high certainty, from the first recognition result obtained by the first text recognition process and the second recognition result obtained by the second text recognition process, and executes a postprocess corresponding to the selected recognition result. For example, the processing unit 24 renders a text which is the first recognition result in a color for the first era, and renders a text which is the second recognition result in a color for the second era. The processing unit 24 may collectively display the text for each era on the display.

In addition, the processing unit 24 may store a recognition result and recognition process information which is information indicating a recognition process from which the recognition result is obtained in association with each other, in the memory. For example, in a case of selecting the first recognition result from the first recognition result and the second recognition result, the processing unit 24 stores the selected first recognition result with the recognition process information indicating the first text recognition process in association with each other, in the memory. In a case of selecting the second recognition result, the processing unit stores the selected second recognition result and the recognition process information indicating the second text recognition process in association with each other, in the memory.

The function of each unit of the information processing apparatus 10 described above is realized by cooperation of hardware and software, as an example. For example, the function of each apparatus is realized by a processor of each apparatus reading and executing a program stored in a memory of each apparatus. The program is stored in the memory via a recording medium such as a CD or DVD, or via a communication path such as a network.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire each recognition result output by each of a plurality of different recognition processes for the same image; and
execute, in relation to the recognition result selected from among the recognition results output by each of the plurality of recognition processes, a postprocess corresponding to the recognition process from which the selected recognition result is output.

2. The information processing apparatus according to claim 1, wherein the processor is configured to:
acquire a certainty degree which each of the plurality of recognition processes outputs in association with the recognition result, and
execute the postprocess on the selected recognition result based on the certainty degree.

3. The information processing apparatus according to claim 1, wherein the processor is configured to:
execute, in a case where the recognition process from which the selected recognition result is output is a handwritten text recognition process, a confidentiality process for the selected recognition result or the image, as the postprocess.

4. The information processing apparatus according to claim 2, wherein the processor is configured to:
execute, in a case where the recognition process from which the selected recognition result is output is a handwritten text recognition process, a confidentiality process for the selected recognition result or the image, as the postprocess.

5. The information processing apparatus according to claim 1,
wherein the image is an image of a partial area in an entire image, and
the processor is configured to:
acquire the recognition result and execute the postprocess for the image of the area, for each area in the entire image, and
execute, in a case where the recognition process from which the selected recognition result is output is a handwritten text recognition process, a process corresponding to an item indicated by a recognition result for a second image that is an image in a vicinity of the image in the entire image and for which a recognition result of a print text recognition process is selected, as the postprocess.

6. The information processing apparatus according to claim 2,
wherein the image is an image of a partial area in an entire image, and
the processor is configured to:
acquire the recognition result and execute the postprocess for the image of the area, for each area in the entire image, and
execute, in a case where the recognition process from which the selected recognition result is output is a handwritten text recognition process, a process corresponding to an item indicated by a recognition result for a second image that is an image in a vicinity of the image in the entire image and for which a recognition result of a print text recognition process is selected, as the postprocess.

7. The information processing apparatus according to claim 3,
wherein the image is an image of a partial area in an entire image, and
the processor is configured to:
acquire the recognition result and execute the postprocess for the image of the area, for each area in the entire image, and
execute, in a case where the recognition process from which the selected recognition result is output is a handwritten text recognition process, a process corresponding to an item indicated by a recognition result for a second image that is an image in a vicinity of the image in the entire image and for which a recognition result of a print text recognition process is selected, as the postprocess.

8. The information processing apparatus according to claim 4,
wherein the image is an image of a partial area in an entire image, and
the processor is configured to:
acquire the recognition result and execute the postprocess for the image of the area, for each area in the entire image, and
execute, in a case where the recognition process from which the selected recognition result is output is a handwritten text recognition process, a process corresponding to an item indicated by a recognition result for a second image that is an image in a vicinity of the image in the entire image and for which a recognition result of a print text recognition process is selected, as the postprocess.

9. The information processing apparatus according to claim 1, wherein the processor is configured to:
execute, in a case where the recognition process from which the selected recognition result is output is a process in which the image is recognized as an image representing a text in a first language and a text code is output as the recognition result, a process of drawing a text glyph indicated by the text code in a glyph set of the first language as the text glyph indicated by the text code, as the postprocess.

10. The information processing apparatus according to claim 2, wherein the processor is configured to:
execute, in a case where the recognition process from which the selected recognition result is output is a process in which the image is recognized as an image representing a text in a first language and a text code is output as the recognition result, a process of drawing a text glyph indicated by the text code in a glyph set of the first language as the text glyph indicated by the text code, as the postprocess.

11. A non-transitory computer readable medium storing a program causing a computer to execute a process comprising:
acquiring each recognition result output by each of a plurality of different recognition processes for the same image; and
executing, in relation to the recognition result selected from among the recognition results output by each of the plurality of recognition processes, a postprocess corresponding to the recognition process from which the selected recognition result is output.

12. An information processing apparatus comprising:
means for acquiring each recognition result output by each of a plurality of different recognition processes for the same image; and
means for executing, in relation to the recognition result selected from among the recognition results output by each of the plurality of recognition processes, a postprocess corresponding to the recognition process from which the selected recognition result is output.
